(19) United States
(12) Patent Application Publication
(10) Pub. No.: US 2012/0304074 A1
(43) Pub. Date: Nov. 29, 2012

(54) DEVICE USER INTERFACE TO INPUT EMOJI AND OTHER SYMBOLS

(75) Inventors: KEITA OOI, TOKYO (JP); ERIC MATTHEW BELL, SEATTLE, WA (US); YASUHIKO MORI, TOKYO (JP); TAKETOSHI YOSHIDA, TOKYO (JP); SONGMING HE, YOKOHAMA (JP); LIANG CHEN, REDMOND, WA (US)

(73) Assignee: MICROSOFT CORPORATION, REDMOND, WA (US)

(21) Appl. No.: 13/211,038

(22) Filed: Aug. 16, 2011

Related U.S. Application Data
(60) Provisional application No. 61/489,088, filed on May 23, 2011.

(51) Int. Cl. G06F 3/048

(52) U.S. Cl. 715/752

(57) ABSTRACT

An integrated symbols user interface (UI) provides a collection of different symbols for inputting symbols into messages, such as email message, IM messages, and SMS text messages. The integrated symbols UI may group symbols in a number of different category panes. Additionally, the integrated symbols UI may provide a history pane with previously used symbols. Only a portion of the integrated symbols UI may be displayed on a display screen of device at a time. A user may seamlessly pan over the integrated symbols UI to move between the panes. In some embodiments, the integrated symbols UI may also include a category list pane that allows a user to navigate directly to a particular category pane or the history pane.

### CROSS-REFERENCE TO RELATED APPLICATIONS

This application claims the benefit of U.S. Provisional Application No. 61/489,088, filed May 23, 2011, which is herein incorporated by reference in its entirety.

### BACKGROUND

For mobile users, it is common to enter emoji, emoticons, and other symbols into messages, such as email messages, instant messaging (IM) messages, and short message service (SMS) text messages. This is especially true in countries like Japan, in which emoji and other symbols are particularly popular and enjoy widespread use. There are many variations of symbols that users may wish to include in messages. These may include character-based emoji that are created by a combination of characters (these may be defined by a mobile operator), image-based emoji, ASCII art created from a combination of ASCII characters, emoticons, and other symbols. Currently, when users input these symbols using mobile devices, there are typically different user interfaces and entry points to access and select the various symbols, making it burdensome to users.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to an integrated symbols user interface (UI) that provides a collection of different symbols for inputting symbols into messages, such as email messages, IM messages, and SMS text messages. The integrated symbols UI may group symbols in a number of different category panes. Additionally, the integrated symbols UI may provide a history pane with previously used symbols. Only a portion of the integrated symbols UI may be displayed on a display screen of a device at a time. A user may seamlessly pan over the integrated symbols UI to move between the panes. In some embodiments, the integrated symbols UI may also include a category list pane that allows a user to navigate directly to a particular category pane or the history pane.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a diagram illustrating an integrated symbols UI in accordance with an embodiment of the present invention;

FIGS. 3A-C are diagrams illustrating panning horizontally across an integrated symbols UI to move between category panes in accordance with an embodiment of the present invention;

FIG. 4 is a diagram illustrating a history pane of an integrated symbols UI in accordance with an embodiment of the present invention;

FIG. 5 is a diagram illustrating an integrated symbols UI with a category list pane that is statically located above the other panes of the integrated symbols UI in accordance with an embodiment of the present invention;

FIG. 6 is a diagram illustrating an integrated symbols UI with panes of varying height in accordance with an embodiment of the present invention;

FIGS. 7A and 7B are diagrams illustrating panning vertically across a category pane of an integrated symbols UI in accordance with an embodiment of the present invention;

FIG. 8 is a diagram illustrating removing unavailable categories from a category list pane of an integrated symbols UI in accordance with an embodiment of the present invention;

FIG. 9 is a diagram illustrating graying out unavailable symbols for a category pane of an integrated symbols UI in accordance with an embodiment of the present invention;

FIG. 10 is a flow diagram showing a method for providing an integrated symbols UI for entering a symbol into a message being composed by a user in accordance with an embodiment of the present invention;

FIG. 11 is a flow diagram showing a method for panning over an integrated symbols UI in accordance with an embodiment of the present invention;

FIG. 12 is a flow diagram showing a method for employing a category list to navigate an integrated symbols UI in accordance with an embodiment of the present invention;

FIG. 13 is a flow diagram showing a method for selecting and/or arranging symbols for a history pane of an integrated symbols UI in accordance with an embodiment of the present invention; and

FIG. 14 is a flow diagram showing a method for displaying available symbols in a manner different from unavailable symbols in an integrated symbols UI in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to providing an integrated symbols user interface (UI) that integrates various types of symbols. The symbols may include a variety of different character-based and image-based symbols, including, without limitation, emoji, kaomoji, decome, ASCII art, and emoticons. As used herein, “character-based symbols” refer to symbols that are created from a combination of characters, while “image-based symbols” are symbols that comprise an image instead of characters. The integrated symbols UI may treat the various symbols as equivalent items and provide a single entry point and mechanism for accessing and selecting from available symbols when users are generating various different types of messages. By way of example only and not limitation, the integrated symbols UI may be provided for entry of symbols into email messages, instant messaging (IM) messages, and short message service (SMS) text messages.

The integrated symbols UI may be comprised of a number of category panes that group symbols into different categories. The integrated symbols UI may also have a history pane that includes symbols previously used to allow a user to quickly access those symbols. The integrated symbols UI may also have a category list pane that lists the various panes of the UI and allows the user to select from the list to navigate directly to the selected pane. The integrated symbols UI may further be configured to allow a user to seamlessly pan over various portions to move between the categories and other panes as will be described in further detail below.

Accordingly, in one aspect, an embodiment of the present invention is directed to a method for providing an integrated symbols UI for entering a symbol into a message being composed by a user. The method includes presenting a portion of an integrated symbols UI on a display area of a device. The integrated symbols UI includes a history pane that includes symbols previously used by a user, and a plurality of category panes including a plurality of symbols available for entry into different types of messages. The method also includes allowing the user to seamlessly pan over the integrated symbols UI in at least one direction to move between the history pane and plurality of category panes. The method further includes receiving a selection of a symbol from the integrated symbols UI. The method still further includes providing the symbol within the message being composed by the user.

In another embodiment of the invention, an aspect is directed to a mobile device. The mobile device includes a display screen, and a processor configured to present an integrated UI on the display screen. The integrated symbols UI includes a history pane that includes symbols previously used by a user. The integrated symbols UI also includes a plurality of category panes including a plurality of symbols available for entry into different types of messages that may be transmitted by the mobile device. Only a portion of the integrated symbols UI is displayed on the display screen at a time, and the integrated symbols UI is configured to allow a user to seamlessly pan over the integrated symbols UI in at least one direction to move between the history pane and plurality of category panes.

A further embodiment of the invention is directed to one or more computer storage media storing computer-useable instructions that, when used by a computing device, cause the computing device to present an integrated symbols UI on a display screen of the computing device. The integrated symbols UI includes a history pane that includes symbols previously used by a user, and a plurality of category panes including a plurality of symbols available for entry into different types of messages that may be transmitted by the computing device. Only a portion of the integrated symbols UI is displayed on the display screen at a time, and the integrated symbols UI is configured to allow a user to seamlessly pan over the integrated symbols UI in at least one direction to move between the history pane and plurality of category panes.

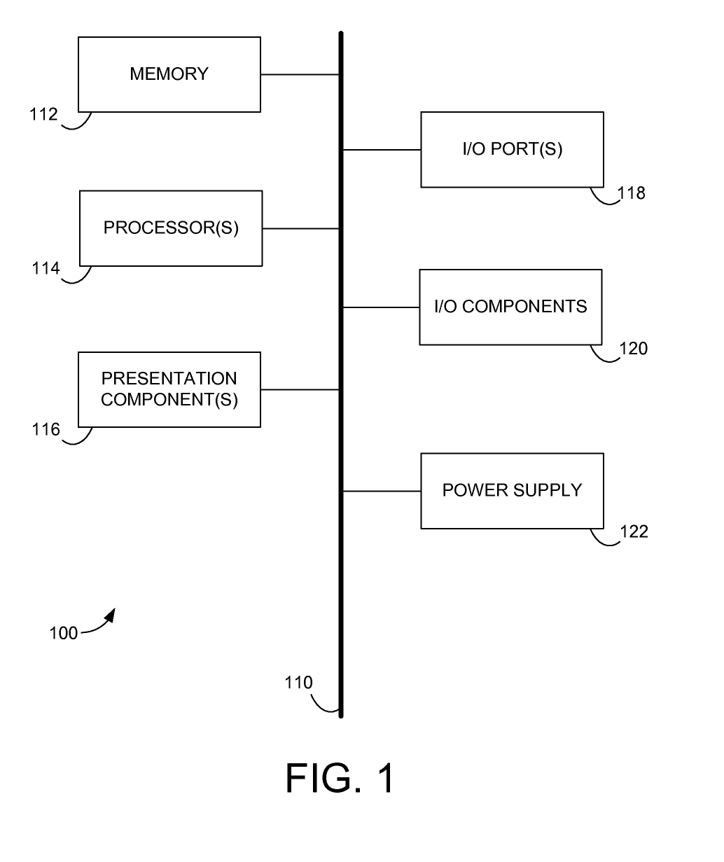

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

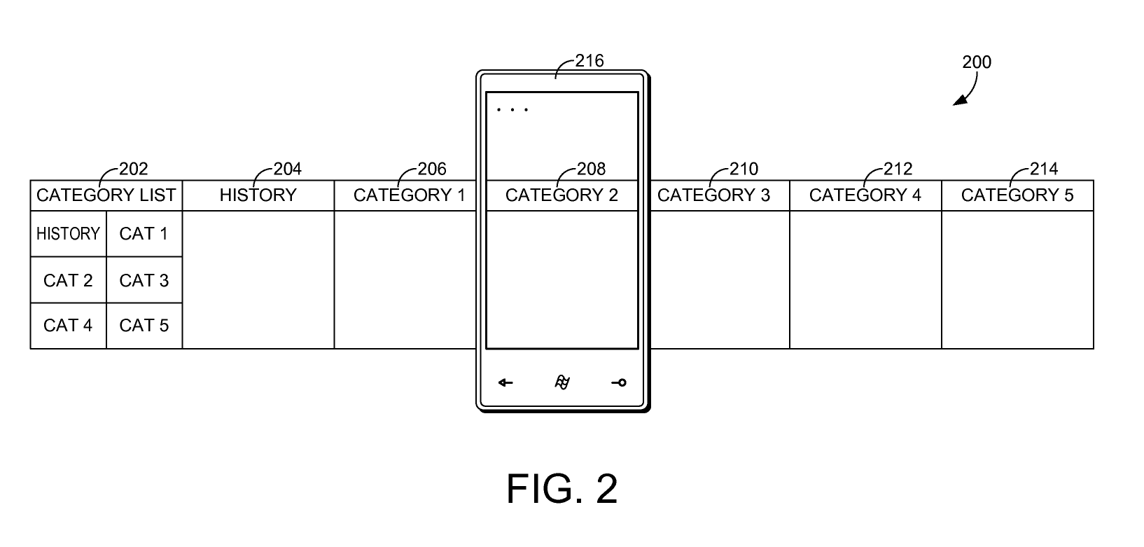

Referring now to FIG. 2, a diagram is provided illustrating an integrated symbols user interface (UI) 200 in accordance with an embodiment of the present invention. The integrated symbols UI 200 may contain any of a variety of different character-based and image-based symbols, including, without limitation, emoji, kaomoji, decome, ASCII art, and emoticons. As such, the integrated symbols UI 200 treats the various symbols as equivalent items and provides an integrated UI for allowing a user to access the various symbols and enter a desired symbol into a message being composed. It should be noted that the integrated symbols UI 200 has been displayed in FIG. 2 with symbols removed for simplification purposes.

As shown in FIG. 2, the integrated symbols UI 200 includes a number of panes or columns, including a category list pane 202, a history pane 204, and several category panes 206, 208, 210, 212, 214. Symbols are grouped together into different categories and included in the various category panes 206, 208, 210, 212, 214 of the integrated symbols UI 200 according to the groupings. Although five category panes 206, 208, 210, 212, 214 are shown in the integrated symbols UI 200 of FIG. 2, it should be understood that any number of category panes may be included in an integrated symbols UI in accordance with the various embodiments of the present invention. In particular, the groupings of symbols into different categories may be done in any number of different ways as determined suitable to meet user needs for finding and accessing symbols in the UI.

When a device displays the integrated symbols UI 200, only a part of the integrated symbols UI 200 is displayed at a time. This is represented in FIG. 2, in which a mobile device 216 is shown with the pane 208 of category 2 currently being displayed on the display screen of the mobile device 216. Conceptually, the integrated symbols UI 200 could be viewed as a panorama, and a mobile device provides a view into only a portion of the overall panorama at a time. Although only a single category or pane (i.e., the pane 208 of category 2) is shown on the display of the device 216 in FIG. 2, it should be understood that the portion of the integrated symbols UI 200 included in the display of a device may include a single pane only, or at least portions of multiple panes. For instance, the display may include the extent of one pane and portions of panes to the left and right of that pane. As another example, the display may include the extent of multiple panes. Any and all such variations are contemplated to be within the scope of embodiments of the present invention.

A user may move between the categories and other panes of the integrated symbols UI 200 seamlessly by horizontally panning over the integrated symbols UI 200. For instance, a user may pan from the pane 208 for category 2 to the pane 210 for category 3 by swiping left on the display screen of the mobile device 216 or using another form of gesture or other input to pan to the right on the integrated symbols UI 200 Likewise, the user may pan from the pane 208 for category 2 to the pane 206 for category 1 by swiping right on the display screen of the mobile device 216 or using another form of gesture or other input. As such, the user may navigate over the integrated symbols UI 200 to pan left and right and view the various panes. In some embodiments, the panning may be “circular” in the sense that the user may pan right from the pane 214 for category 5 to move to the pane 202 for the category list and vice versa.

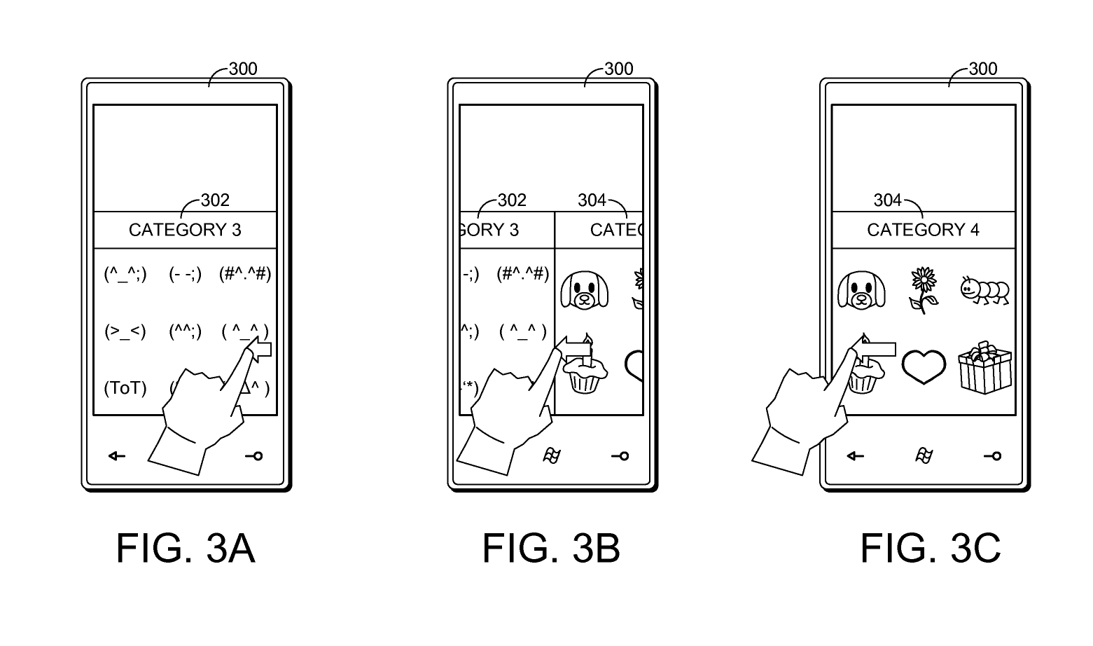

Seamless panning from one category to another is illustrated by FIGS. 3A-3C. Initially, as shown in FIG. 3A, a pane 302 for category 3 of an integrated symbols UI is displayed on the display screen of a mobile device 300. When the user begins swiping the screen towards the left, the displayed portion of the integrated symbols UI horizontally pans to the right. This is illustrated in FIG. 3B, which shows the pane 302 for category 3 moving to the left and a pane 304 for category 4 entering the display screen from the right. As shown in FIG. 3C., as the user finishes swiping the screen to the left, the transition from displaying the pane 302 for category 3 to the pane 304 for category 4 is completed. As a result, the pane for category 4 is now displayed on the mobile device 300. Although FIGS. 3A through FIGS. 3C illustrate panning from one pane to the next immediate pane, it should be understood that a user may pan over multiple panes, for instance, based on the length and/or speed of the user's swipe.

Referring again to FIG. 2, in addition to grouping symbols in the various category panes 206, 208, 210, 212, 214, the integrated symbols UI 200 includes a history pane 204 that lists symbols that have been previously used on the device 216. Including previously used symbols in the history pane 204 may allow the user to quickly access those symbols.

The number of symbols included in the history pane 204 may be limited. Which symbols are included in the history pane 204 and/or how the symbols are arranged within the history pane 204 may be based any combination of a number of different factors in accordance with embodiments of the present invention. In some embodiments, the symbols may be selected and/or arranged in the history pane 204 based on the symbols' recency of use by the user. For instance, the history pane 204 may include the symbols most recently used by the user and/or the symbols may be ordered based on recency of use starting with the most recently used symbol at the top left of the history pane 204 and filling in the remainder of the history pane 204 according to declining recency.

In some embodiments, symbols may be included and/or arranged in the history pane 204 based on the frequency of use of the symbols. The frequency of use of different symbols may be determined over some defined period of time (e.g., over the past day, past week, past month) or based on a defined number of total symbol selections by the user (e.g., past 100 selections, past 1000 selections, etc.). By way of example, the history pane 204 may include the symbols most frequently used by the user and/or the symbols may be ordered based on the frequency of use starting with the most frequently used symbol at the top left of the history pane 204 and filling in the remainder of the history pane 204 according to declining frequency of use.

The symbols may also be selected and/or arranged in the history pane 204 by category. In particular, the symbols may be grouped together in the history pane 204 according to the categories to which the symbols belong. For instance, symbols from category 1 may be included first, following by symbols from category 2, and so on.

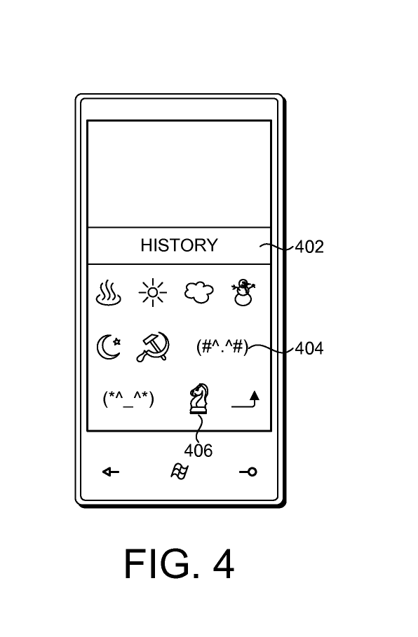

The integrated symbols UI 200 may include symbols of varying size. Accordingly, the symbols may be selected and/or arranged in the history pane 204 based on size to accommodate the symbols. This is illustrated in FIG. 4. As shown in FIG. 4, a history pane 402 is displayed with different-sized symbols. For instance, symbol 404 is wider than other symbols, such as symbol 406. Based on the varying sizes, the symbols may be arranged, for instance, to avoid blank spaces or otherwise wasted space in the history pane 402.

It should be understood that the symbols included in a history pane and the arrangement of the symbols may be based on any combination of the above-noted factors, as well as other factors. By way of example to illustrate, the most recently used symbols may be included in a history pane, and the symbols may be arranged in the history pane based on frequency of use. Any and all such variations are contemplated to be within the scope of embodiments of the present invention.

Returning to FIG. 2, in addition to seamlessly panning across panes, another way for a user to navigate the integrated symbols UI 200 is through use of a category list pane 202 that allows a user to jump to a particular category or other pane. The category list pane 202 includes a list of the panes included in the integrated symbols UI 200, including the history pane 204 and each of the category panes 206, 208, 210, 212, 214. When the category list pane 202 is displayed, the user may select from the list, and in response, the pane corresponding with the user's selection is displayed. For instance, if the user were to select “CAT 4” from the category list pane 202, the pane 212 for category 4 would be displayed. This provides a quick way for a user to navigate directly to a desired category within the integrated symbols UI 200.

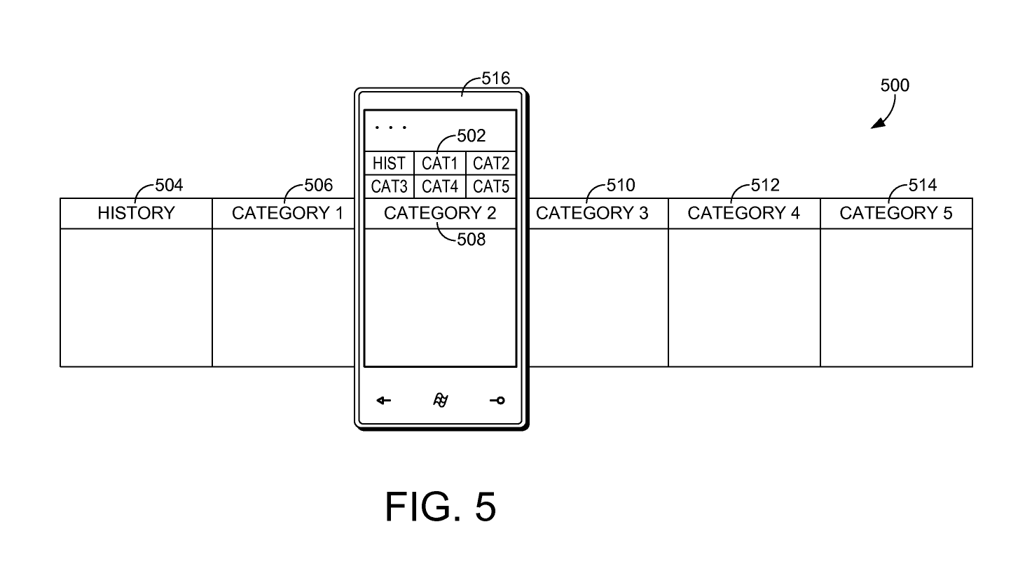

Although FIG. 2 illustrates an embodiment in which the category list pane 202 is included on one end of the integrated symbols UI 200 (such that it may be accessed by panning over to that portion of the UI 200), a category list pane may be provided in other manners in other embodiments of the present invention. For instance, in some embodiments, a category list pane may be provided as a static portion that remains displayed on the display screen while the user pans over the other panes of the integrated symbols UI. By way of example to illustrate, FIG. 5 illustrates an integrated symbols UI 500 with a category list pane 502 that is statically located above the history pane 504 and category panes 506, 508, 510, 512, 514. As such, when the user pans over the panes 504, 506, 508, 510, 512, 514, the category list pane 502 remains on the display screen of the mobile device 516. Accordingly, the user may select from the category list pane 502 at any time to jump to a particular pane in the integrated symbols UI 500. Although FIG. 5 illustrates an embodiment in which the category list pane 502 is displayed above the other panes, it should be understood that a category list pane may be statically displayed in other locations (e.g., below the other panes).

In other embodiments, a category list pane may be provided separate from the other panes of an integrated symbols UI. For instance, an integrated symbols UI may be provided that allows the user to pan over a history pane and category panes. The user may then access a category list pane by selecting a particular hard key provided on a mobile device (e.g., a back key) and/or a virtual key displayed on the display screen of the mobile device. In response, the category list pane is displayed, and the user may then select from the category list pane to jump to the history pane or a category pane in the integrated symbols UI. The user may again access the category list pane at any time by selecting the particular hard key or virtual key configured to provide access to the category list pane.

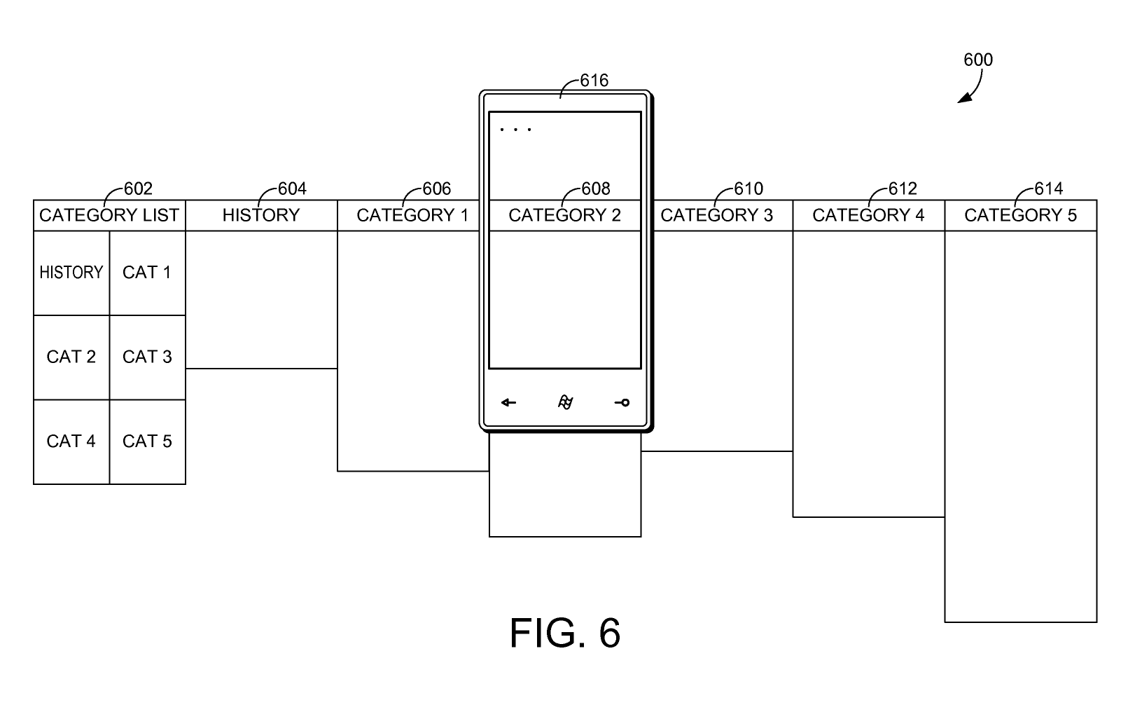

In FIG. 2, each of the panes 202, 204, 206, 208, 210, and 212 are shown with a common height that does not extend beyond the display screen area. In another embodiment, as illustrated in FIG. 6, an integrated symbols UI 600 may include panes 602, 604, 606, 608, 610, 612, 614 of varying height that may extend vertically beyond the display screen area of a mobile device 616. Similar to that described above with reference to FIGS. 2 and 3A-3C, a user may pan horizontally over the integrated symbols UI 600 to view the various panes within the display area of the mobile device 616. When a pane is displayed that extends beyond the display screen area of the mobile device 616, only a part of the pane will be displayed. For instance, FIG. 6 illustrates the pane 608 of category 2 being displayed by the mobile device, with only a portion of the pane 608 being displayed. A user may pan vertically over the displayed pane 608 to view the symbols within the extent of the pane 608. It should be noted that the integrated symbols UI 600 has been displayed in FIG. 6 with symbols removed for simplification purposes.

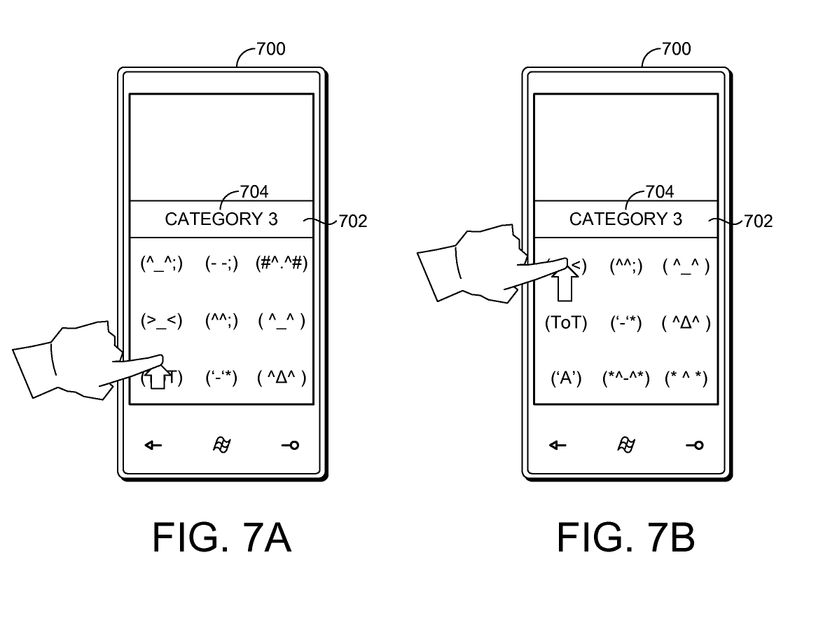

FIGS. 7A and 7B illustrate vertical panning over a pane 702 that extends beyond the display screen of a mobile device 700. As shown in FIG. 7A, the pane 702 for category 3 is displayed. As the user swipes up on the display screen of the mobile device 700, the display pans down on the pane 702 as shown in FIG. 7B. The panning allows the user to scroll down to view other symbols within the pane 702. The user may be able to pan vertically up and down to view the different symbols. The extent of panning may be controlled by the length and/or the speed of the user's swipe over the display screen. Although FIGS. 7A and 7B illustrate an embodiment in which the header 704 for category 3 remains as the user pans vertically downward (while top symbols are no longer displayed), in other embodiments, the header 704 may be scrolled off the display as the user pans down. In some embodiments, if more than one pane is displayed on the display screen, only a single pane may be panned over vertically at a time. In other words, the pane may be scrolled independently of panes to the sides of that pane.

In operation, a user may access an integrated symbols UI to input symbols when generating a message. For instance, when a user is composing a message, a virtual key or other user-selectable feature may be provided to allow the user to access an integrated symbols UI. After the user accesses the integrated symbols UI, the user may then pan over the integrated symbols UI to find a desired symbol. When the user selects a symbol, the symbol is placed at a desired location within the user's message. In some embodiments, after a symbol is selected, the integrated symbols UI may be removed and a keyboard or other virtual input mechanism may be displayed.

The integrated symbols UI may be provided to insert symbols for a variety of different types of messages. By way of example only and not limitation, the integrated symbols UI may be provided for inputting symbols into emails, IM messages, and SMS text messages. In some instances, some symbols may not be compatible with certain types of messages. For instance, some instant message services may only support certain symbols. Accordingly, in some embodiments of the present invention, categories of symbols and/or particular symbols that are not available for use may be removed from the display of the integrated symbols UI or may be displayed differently than the categories and/or symbols that are available for use.

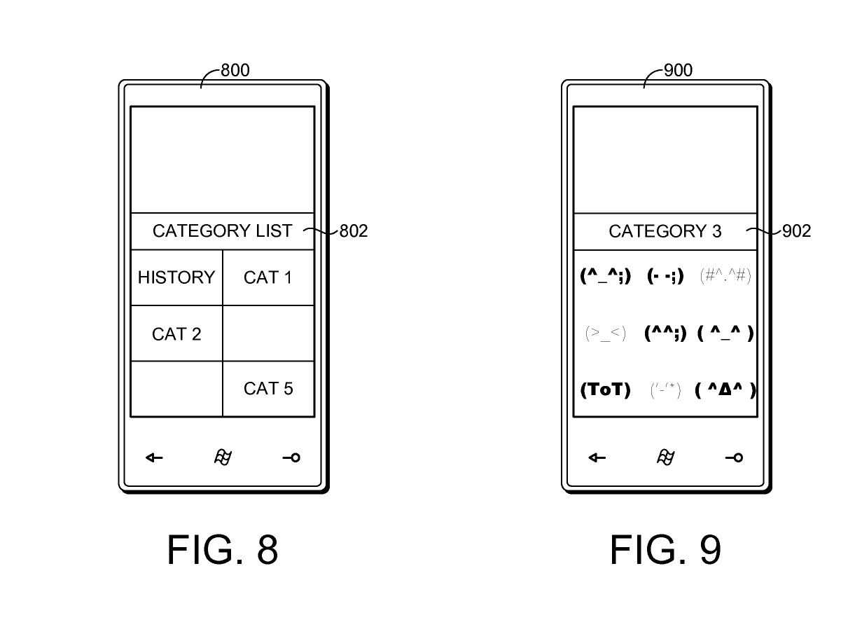

By way of illustration, FIG. 8 shows a mobile device 800 displaying a category list 802, in which categories that are unavailable based on the type of message being composed are removed from the display. In particular, categories 3 and 4 are not available and therefore have been removed. As another example, FIG. 9 shows a mobile device 900 displaying a pane 902 for category 3, in which available symbols are shown bolded while unavailable symbols have been grayed out. It should be understood that other approaches for displaying available categories and/or symbols different than unavailable categories and/or symbols may be employed with the scope of embodiments of the present invention.

Although embodiments have been described herein in which a user may pan horizontally between panes of an integrated symbols UI, in other embodiments, an integrated symbols UI may be configured to allow a user to pan vertically between panes. Additionally, although embodiments have been described herein in which a user may pan vertically over the extent of a displayed pane, in other embodiments, an integrated symbols UI may be configured to allow a user to pan horizontally over the extent of a displayed pane. Further, while embodiments illustrated in FIGS. 2-9 illustrate integrated symbols UIs consuming only a portion of the display screen area of a mobile device (with the remaining portion displaying, for instance, the message being composed), the integrated symbol UIs may consume any portion of the display screen area or may consume the entire display screen area. Any and all such variations are contemplated to be within the scope of embodiments of the present invention.

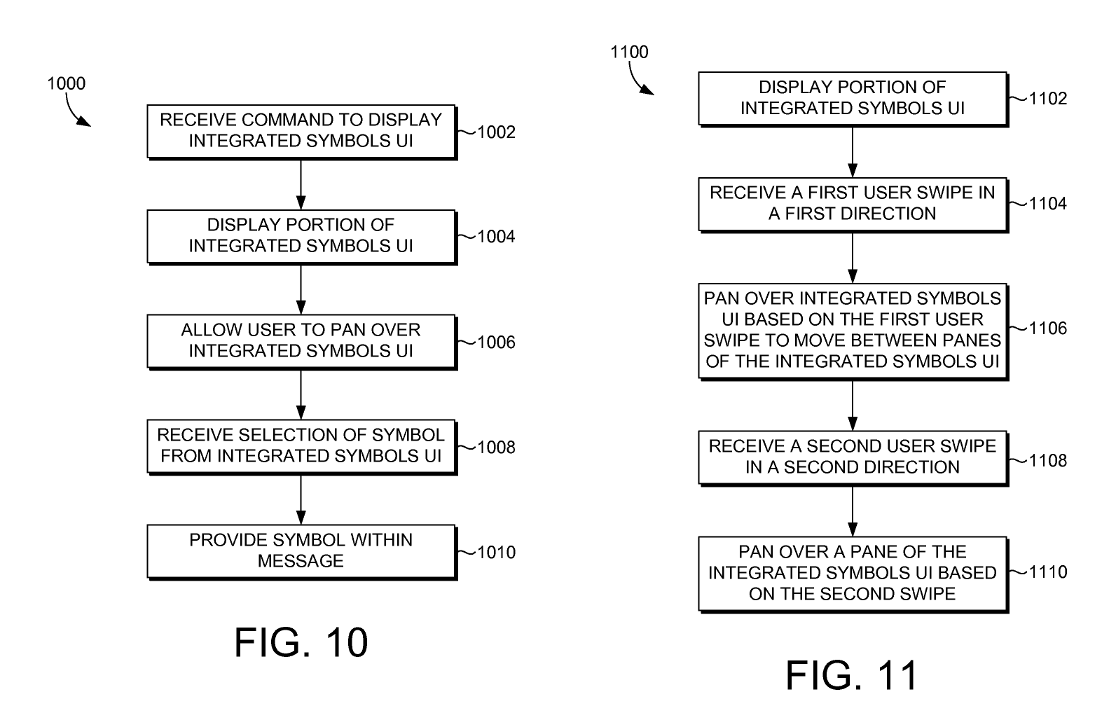

Turning now to FIG. 10, a flow diagram is provided that illustrates a method 1000 for providing an integrated symbols UI for entering a symbol into a message being composed by a user in accordance with an embodiment of the present invention. As shown at block 1002, a command to display an integrated symbols UI is received. For instance, a user may be composing a message (e.g., an email message, IM message, text message, etc.) and may decide to enter a symbol into the message. As such, the user may select an option to access the integrated symbols UI.

In response to the command, a portion of the integrated symbols UI is displayed on the display screen of the device, as shown at block 1004. As discussed herein, the integrated symbols UI may include a number of panes, including a history pane and multiple category panes, and only a portion of the integrated symbols may be displayed at any given time. As shown at block 1006, the user may navigate the integrated symbols UI by panning over the UI. For instance, in one embodiment, the user may move between panes of the integrated symbols UI by panning horizontally. Additionally, if a pane extends vertically beyond the display screen area of the device, the user may pan vertically over the pane.

When the user locates a desired symbol, the user may select the symbol from the integrated symbols UI, as shown at block 1008. In response to the user's selection, the selected symbol is placed within the message being composed by the user.

With reference to FIG. 11, a flow diagram is provided that illustrates a method 1100 for panning over an integrated symbols UI in accordance with an embodiment of the present invention. As shown at block 1102, a portion of an integrated symbols UI is displayed by a display screen of a device. A first user swipe in a first direction is received at block 1104. For instance, the user may swipe horizontally toward the left or right. In response to the first direction of the first user swipe, the display pans over the integrated symbols UI to move between panes of the integrated symbols UI, as shown at block 1106. As such, the user may view different categories of symbols within the integrated symbols UI.

As show at block 1108, a second user swipe in a second direction is received. The second direction may be perpendicular to the first direction. For instance, the first swipe may have been a horizontal swipe to the left or right, while the second swipe may be a vertical swipe up or down. In response to the second direction of the second user swipe, the display pans over a pane currently displayed in the display screen to view other portions of the pane, as shown at block 1110. As such, the user may view additional symbols contained in a category being viewed.

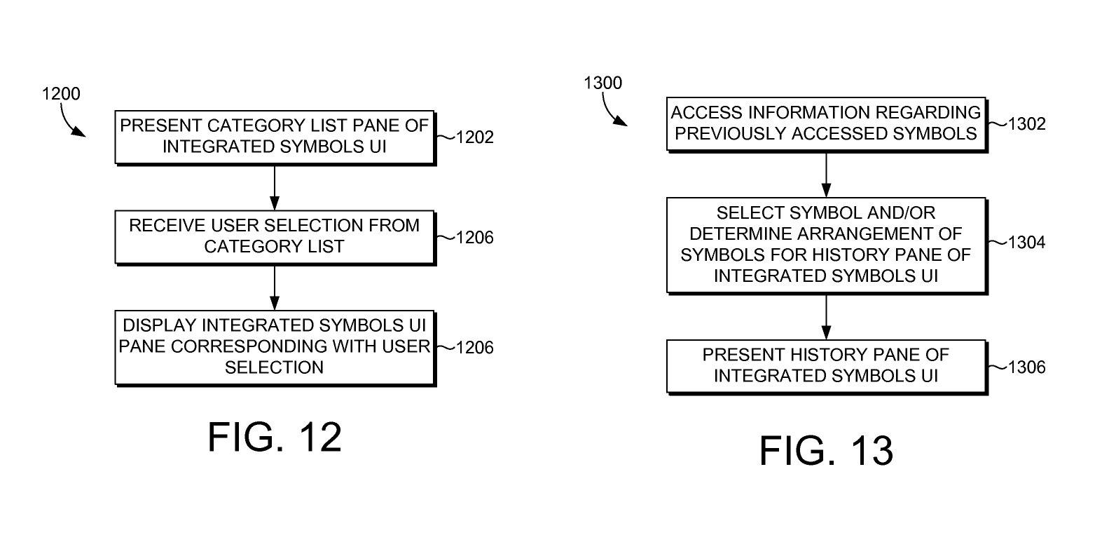

Referring to FIG. 12, a flow diagram is provided that illustrates a method 1200 for employing a category list to navigate an integrated symbols UI in accordance with an embodiment of the present invention. As shown at block 1202, a category list pane of an integrated symbols UI is presented on the display screen of a device. The category list pane may list the various categories of symbols contained within the integrated symbols UI. In some embodiments, the category list pane may also list a history pane.

The user may review the various options listed by the category list pane and choose a selection. Accordingly, a user selection from the category list is received, as shown at block 1204. In response to the user selection, the pane of the integrated symbols UI corresponding to the list section is displayed on the display screen of the device, as shown at block 1206.

FIG. 13 illustrates a flow diagram showing a method 1300 for selecting and/or arranging symbols for a history pane of an integrated symbols UI in accordance with an embodiment of the present invention. As shown at block 1302, information regarding symbols previously accessed by a user of the device is accessed. The information may be accessed, for instance, when the used accesses the integrated symbols UI or prior to displaying the history pane. The accessed information may include, for instance, frequency of use of symbols, recency of use of symbols, symbol size, and symbol categories. Based on the accessed information, the symbols to include in the history pane and/or the arrangement of the symbols within the history pane are determined, as shown at block 1304. The history pane of the integrated symbols UI may then be presented, as shown at block 1306.

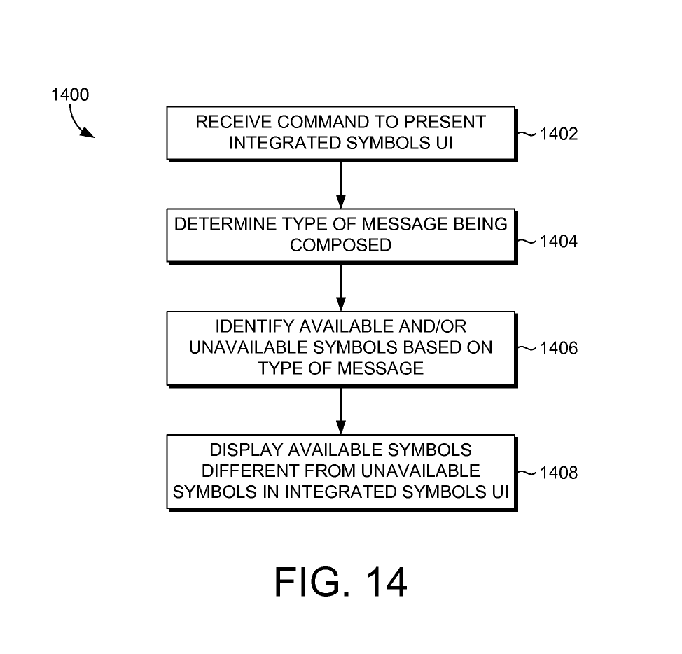

Referring next to FIG. 14, a flow diagram is provided that illustrates a method 1400 for displaying available symbols in a manner different from unavailable symbols in an integrated symbols UI in accordance with an embodiment of the present invention. As shown at block 1402, a command to present an integrated symbols UI is received. The command may be received when the user is composing a message. The type of message being composed is determined, as shown at block 1404. For instance, the message may be an email message, IM message, or SMS text message. Based on the type of message, available and/or unavailable symbols are identified, as shown at block 1406. For instance, some types of messages may not support certain symbols such that those symbols are not available for those messages. Based on the determination, available symbols are displayed in the integrated symbols UI differently than unavailable symbols. For instance, in some embodiments, the unavailable symbols may be grayed out or the unavailable symbols may be removed from display. Although FIG. 14 discusses displaying available and unavailable items differently based on the type of message being composed, a similar approach may be provided for treating categories of symbols that are available and unavailable based on the type of message.

As can be understood, embodiments of the present invention provide an integrated symbols user interface that provides a single, integrated access point for selecting symbols to enter into messages. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for providing an integrated symbols user interface (UI) for entering a symbol into a message being composed by a user, the method comprising:
presenting a portion of an integrated symbols UI on a display area of a device, the integrated symbols UI including:
a history pane that includes symbols previously used by a user, and
a plurality of category panes including a plurality of symbols available for entry into different types of messages;
allowing the user to seamlessly pan over the integrated symbols UI in at least one direction to move between the history pane and plurality of category panes;
receiving a selection of a symbol from the integrated symbols UI; and
providing the symbol within the message being composed by the user.

2. The method of claim 1, wherein the symbols included in the history pane are selected based on at least one selected from the following: frequency of use, recency of use, symbol size, and symbol category.

3. The method of claim 2, wherein the symbols are arranged in the history pane based on at least one selected from the following: frequency of use, recency of use, symbol size, and symbol category.

4. The method of claim 1, wherein the integrated symbols UI includes all symbols available for entry into the message being composed by the user.

5. The method of claim 1, wherein the integrated symbols UI includes a category list pane that lists the plurality of categories and allows a user to select a particular category to navigate directly from the category list pane to the particular category.

6. The method of claim 5, wherein the category list pane is persistently displayed while the user pans over the integrated symbols UI to move between the history pane and plurality of category panes.

7. The method of claim 1, wherein the integrated symbols UI is configured to allow the user to pan horizontally over the integrated symbols UI to move between the history pane and plurality of category panes.

8. The method of claim 1, wherein a first category pane from the plurality of category panes has a height that extends beyond the display area of the device, and wherein the method further comprises allowing the user to pan vertically over the first category pane.

9. The method of claim 1, wherein the integrated symbols UI is presented in response to a user command to present the integrated symbols UI.

10. The method of claim 1, wherein the method further comprises:
identifying the message being composed by the user as a particular type of message;
identifying unavailable symbols based on the particular type of message; and
displaying the unavailable symbols differently than available symbols in the integrated symbols UI.

11. A mobile device comprising:
a display screen; and
a processor configured to present an integrated symbols user interface (UI) on the display screen, the integrated symbols UI comprising:
a history pane that includes symbols previously used by a user, and
a plurality of category panes including a plurality of symbols available for entry into different types of messages that may be transmitted by the mobile device,
wherein only a portion of the integrated symbols UI is displayed on the display screen at a time, and the integrated symbols UI is configured to allow a user to seamlessly pan over the integrated symbols UI in at least one direction to move between the history pane and plurality of category panes.

12. The mobile device of claim 11, wherein the integrated symbols UI includes a category list pane that lists the plurality of categories and allows a user to select a particular category to navigate directly from the category list pane to the particular category.

13. The mobile device of claim 12, wherein the category list pane is persistently displayed while the user pans over the integrated symbols UI to move between the history pane and plurality of category panes.

14. The mobile device of claim 11, wherein the integrated symbols UI is configured to allow the user to pan horizontally over the integrated symbols UI to move between the history pane and plurality of category panes.

15. The mobile device of claim 11, wherein a first category pane from the plurality of category panes has a height that extends beyond the display area of the device, and wherein the integrated symbols UI is further configured to allow the user to pan vertically over the first category pane.

16. One or more computer storage media storing computer-useable instructions that, when used by a computing device, cause the computing device to present an integrated symbols user interface (UI) on a display screen of the computing device, the integrated symbols UI comprising:
a history pane that includes symbols previously used by a user, and
a plurality of category panes including a plurality of symbols available for entry into different types of messages that may be transmitted by the computing device,
wherein only a portion of the integrated symbols UI is displayed on the display screen at a time, and the integrated symbols UI is configured to allow a user to seamlessly pan over the integrated symbols UI in at least one direction to move between the history pane and plurality of category panes.

17. The one or more computer storage media of claim 16, wherein the integrated symbols UI includes a category list pane that lists the plurality of categories and allows a user to select a particular category to navigate directly from the category list pane to the particular category.

18. The one or more computer storage media of claim 16, wherein the symbols included in the history pane are selected and arranged in the history pane based on at least one selected from the following: frequency of use, recency of use, symbol size, and symbol category.

19. The one or more computer storage media of claim 16, wherein the integrated symbols UI is configured to allow the user to pan horizontally over the integrated symbols UI to move between the history pane and plurality of category panes.

20. The one or more computer storage media of claim 16, wherein a first category pane from the plurality of category panes has a height that extends beyond the display area of the device, and wherein the integrated symbols UI is further configured to allow the user to pan vertically over the first category pane.
